(19) United States
(12) Patent Application Publication
(10) Pub. No.: US 2025/0142466 A1
(43) Pub. Date: May 1, 2025

(54) ACCELERATING PROVISIONING OF WIRELESS DEVICE

(71) Applicant: HEWLETT PACKARD ENTERPRISE DEVELOPMENT LP, Spring, TX (US)

(72) Inventors: Guangning Qin, Beijing (CN); Qin Wei, Beijing (CN); Zhijun Ren, Beijing (CN); Chunfeng Wang, Beijing (CN)

(21) Appl. No.: 18/498,253

(22) Filed: Oct. 31, 2023

(51) Int. Cl. H04W 48/20; H04W 12/06; H04W 48/16

(52) U.S. Cl. CPC H04W 48/20; H04W 12/06; H04W 48/16

(57) ABSTRACT

A method for accelerating provisioning of wireless device. The method comprises receiving, by an access point (AP), a mapping of a wireless device and a further AP from a server. The method further comprises receiving, by the AP, presence announcement information from the wireless device. The method further comprises transmitting, by the AP and based on the received mapping, the received presence announcement information to the further AP. The method further comprises receiving, by the AP, response information for the wireless device from the further AP, the response information including an authentication request for the wireless device. The method further comprises transmitting, by the AP, the response information to the wireless device. In this manner, the provisioning ability of the provision AP can be extended to the non-provision AP, the provisioning time can be reduced, and the provisioning process can be accelerated.

### BACKGROUND

Wi-Fi networks typically authenticate wireless devices using a combination of security protocols and methods. The most common authentication methods in Wi-Fi networks are based on the use of encryption keys and passwords. For example, a wireless device may scan for available Wi-Fi networks and select desired network, and then the network may authenticate the wireless device by using pre-shared key or username and password. Once the authentication of the wireless device is successful, a process of key exchange occurs. During this process, encryption keys are established to secure the data transmission.

If the authentication process for the wireless device connecting to the Wi-Fi network experiences delays, the users may have to wait longer time than expected to get online, which may result in a poor user experience. Furthermore, if the authentication process takes too long, some devices may time out and fail to connect to the network. Therefore, users may then need to restart the connection process, resulting in further delays.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example implementations of the present disclosure may be implemented;

FIG. 2 is a flow chart illustrating an example process of exchanging messages between a wireless device and a provision AP via a further AP which is a neighbor of the provision AP according to the implementations of the present disclosure;

FIGS. 3A-3D are schematic diagrams illustrating an example process of exchanging messages between a wireless device and a provision AP via a further AP which is a neighbor of the provision AP according to the implementations of the present disclosure;

FIG. 4 is a flow chart illustrating an example process of exchanging messages between a wireless device and a provision AP via a further AP which is not a neighbor of the provision AP according to the implementations of the present disclosure;

FIGS. 5A-5C are schematic diagrams illustrating an example process of exchanging messages between a wireless device and a provision AP via a further AP which is not a neighbor of the provision AP according to the implementations of the present disclosure;

FIG. 6 is a flow chart illustrating a method, performed by an AP, for accelerating the provisioning of a wireless device according to the implementations of the present disclosure;

FIG. 7 is a flow chart illustrating a method, performed by a server, for accelerating the provisioning of a wireless device according to the implementations of the present disclosure;

FIG. 8 is a diagram illustrating an example AP according to the implementations of the present disclosure; and

FIG. 9 is a diagram illustrating an example server according to the implementations of the present disclosure.

### DETAILED DESCRIPTION

In some traditional schemes, a process for provisioning (i.e., adding a new wireless device into a Wi-Fi network) involves a device, acting as a configurator, provisioning another device, acting as an Enrollee. The process may comprise bootstrapping, authentication, configuration, and access. Device Provisioning Protocol (DPP) is an example way used for configuring and connecting devices to Wi-Fi networks. Herein uses DPP as an example to illustrate the implementations provided by the present disclosure, but it is not intended to limit the means used in the wireless device authentication process.

A DPP Presence Announcement (also referred as DPP chirp herein) is a broadcast message used by a DPP capable device (also referred as DPP device herein) to find configurators around it. When a non-provisioned DPP device is powered up, it walks through preferred channels defined in a DPP specification to broadcast chirp messages. The DPP device may stop and scan on each channel for a period of time (also referred to as dwell time herein), for example 2 seconds, to wait for a DPP authentication request. In some situations, an access point (AP) is a wireless interface of the configurator, and the AP may exchange DPP messages (e.g., 802.11 action frames) with the DPP device. Backend services may play different roles behind the AP to consume the chirp message. For example, a central DPP service may select a provision AP for the DPP device, and a further service may provide bootstrapping information for the DPP device. In some situations, the latency between the provision AP and the backend services, or the high workloads of the backend services may cause the DPP device to receive response messages from the AP in a delayed manner. Therefore, the DPP device may fail to be provisioned because the response time exceeds the dwell time.

Furthermore, in some schemes, when an AP is selected as a provision AP for the DPP device, the AP may hold the provision AP role for several minutes (e.g., 2 minutes) to avoid receiving, by the DPP device, multiple response messages from multiple provision APs (sometimes the multiple provision APs may comprise a DPP Denial of Service attacker). As a result, if the DPP device fails receiving response from the provision AP, it may not be provisioned in the several minutes or it may be provisioned when the next time it broadcasts a chirp message on the channel of the provision AP. In this case, the process of provisioning lasts a long time, and the user experience is bad.

Therefore, the implementations of the present disclosure provide a scheme for accelerating the provisioning of the wireless device. In the scheme, a first AP may receive a chirp message from a wireless device. The first AP may transmit a request to be a provision AP for the wireless device to a server. If the wireless device does not have a provision AP, the server may select the first AP as the provision AP for the wireless device. Then, the server may generate a mapping of the wireless device and the first AP, and transmit the mapping to a second AP, where the mapping indicates that the first AP is the provision AP for the wireless device. When the second AP receives another chirp message from the wireless device, it may transmit the received chirp message to the first AP, and receive response information for the wireless device from the first AP, where the response information includes an authentication request for the wireless device based on the previous provisioning process between the first AP and the wireless device. Then, the second AP may transmit the response information to the wireless device for authenticating the wireless device.

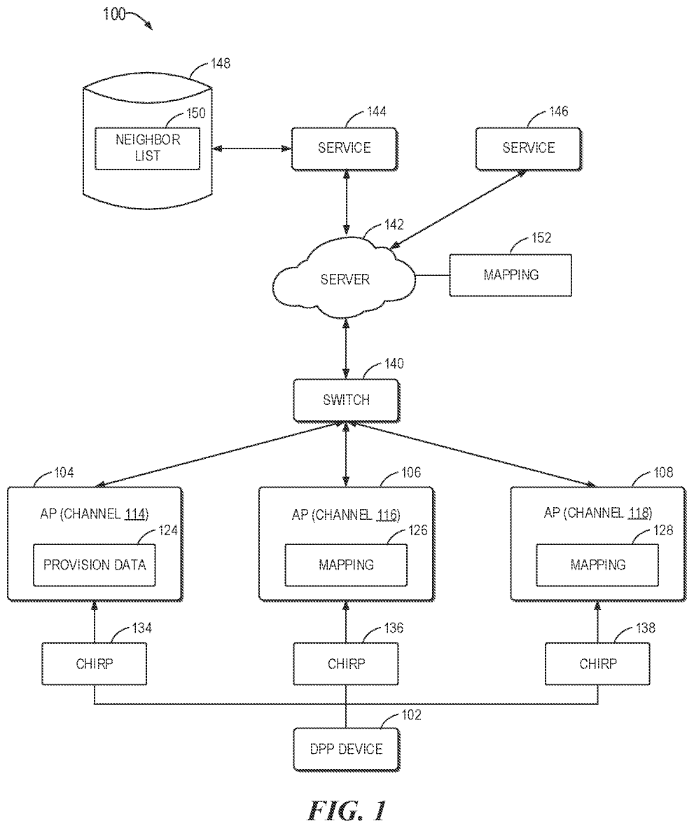

In this manner, although the wireless device stays on the channel of the second AP, it may exchange messages with the first AP via the second AP, and thus the wireless device is able to continue completing the previously provisioning process with the first AP. Therefore, the time for provisioning can be reduced, and the user experience can be improved. Other advantages of implementations of the present disclosure will be described with reference to example implementations as described below. Basic principles and several example implementations of the present disclosure herein are illustrated with reference to FIG. 1 through FIG. 9 as follows.

FIG. 1 illustrates an example environment 100 in which example implementations of the present disclosure may be implemented. As shown in FIG. 1, the environment 100 includes an AP 104 working on channel 114, an AP 106 working on channel 116 and an AP 108 working on channel 118. In the environment 100, the APs 104, 106 and 108 are connected to a switch 140, where the AP 106 is a neighbor of the AP 104, and the AP 108 is not a neighbor of the AP 104. As shown in FIG. 1, in order to connect to a network, a DPP device 102 may walk through the channels 114, 116 and 118 to broadcast chirp messages 134, 136 and 138. A chirp message is a DPP presence announcement broadcasted by a DPP device to announce the presence of the DPP device during a bootstrapping phase. For example, as shown in FIG. 1, the DPP device 102 may announce its presence by broadcasting the chirp message 134 on the channel 114 to help the AP 104 discover it. The AP 104 may receive the chirp message 134 and send a request to a server 142 to apply a provisioning role for the DPP device 102. Multiple backend services, such as backend services 144 and 146, run on the server 142, and the backend services 144 or 146 may select the AP 104 as the provision AP for the DPP device 102.

After the AP 104 is selected as the provision AP for the DPP device 102, the AP 104 may issue DPP authentication request frames on the channel 114, and may wait for a response from the DPP device 102. After successfully receiving a response, the AP 104 may validate the result and transmit a DPP authentication confirm frame to complete the authentication process. After successful completion of these frame exchanges, a secure channel between the AP 104 and the DPP device 102 is established. During this process, the AP 104 may receive provision data 124 required for the authentication from the server 142 (e.g., via the backend services 144 and 146) to response the chirp message 134. However, the time of this process is long, therefore the DPP device 102 may have switched to other channels before receiving the provision data 124 from the AP 104.

In the environment 100, after broadcasting the chirp message 134, the DPP device 102 may stay on the channel 114 for a period of time, for example 2 seconds, and the DPP device 102 may switch to a next channel if it does not receive a response from the AP 104 within 2 seconds. For example, as shown in FIG. 1, if the AP 104 receives the provision data 124 from the server after 2 seconds, such that the DPP device 102 cannot receive a response from the AP 104 within the dwell time, the DPP device 102 may switch to the channel 116 and broadcast the chirp message 136 to announce its presence. In some implementations, the AP 104 may cache the provision data 124 for the DPP device 102. Furthermore, the server 142 may generate a mapping 152 of the DPP device 102 and the AP 104, where the mapping 152 indicates that the provision AP of the DPP device 102 is the AP 104 (e.g., an example of mapping 152 may be [Device1: AP1]). In some implementations, the server 142 may transmit the mapping 152 to all neighbor APs of the AP 104 based on a neighbor list 150 stored on a database 148. In the environment 100, the AP 106 is a neighbor of the AP 104, therefore the AP 106 may receive the mapping 152 and store the mapping 152 as a mapping 126. When the AP 106 receives the chirp message 136 broadcasted by the DPP device 102, the AP 106 may transmit the chirp message 136 to the AP 104 based on the mapping 126. In addition, the AP 104 may response the chirp message 136 with the cached provision data 124 via the AP 106. For example, the AP 104 may transmit an authentication request to the DPP device 102 based on the provision data 124 via the AP 106, and may wait for a response from the DPP device 102.

In the environment 100, the AP 108 is not a neighbor of the AP 104, therefore the AP 108 may not receive the mapping 152 from the server 142. In some implementations, the DPP device 102 fails to receive a response from the AP 104 within the dwell time and switches to the channel 118 to broadcast the chirp message 138. After receiving the chirp message 138, the AP 108 may request the server 142 to apply the provisioning role for the DPP device 102. The server 142 may transmit the mapping 152 to the AP 108, such that the AP 108 may store the mapping 152 as a mapping 128, and transmit the chirp message 138 to the AP 104 via the switch 140. Therefore, the AP 104 may response the chirp message 138 with the cached provision data 124 via the switch 140 and the AP 108. For example, the AP 104 may transmit an authentication request to the DPP device 102 based on the provision data 124 via the switch 140 and the AP 108, and may wait for a response from the DPP device 102.

In this manner, the provisioning ability of the AP 104 can be extended to the AP 106 and the AP 108. The DPP device 102 may be provisioned once the provision data 124 is ready at the AP 104. Therefore, the AP 106 and the AP 108 may provision the DPP device 102 in the case that they are not the provision AP for the DPP device 102. Thus, the time for provisioning can be reduced, and the user experience can be improved.

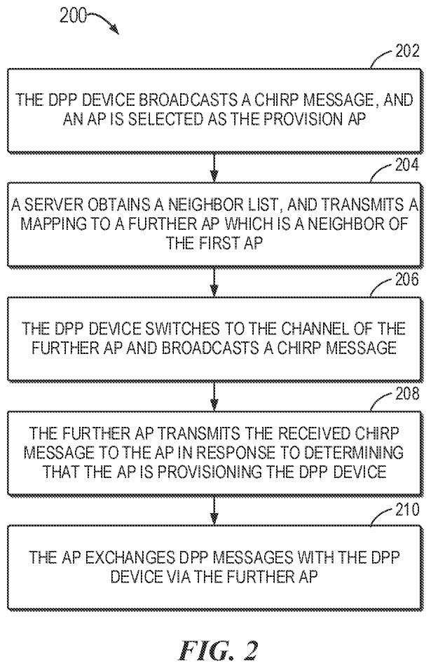

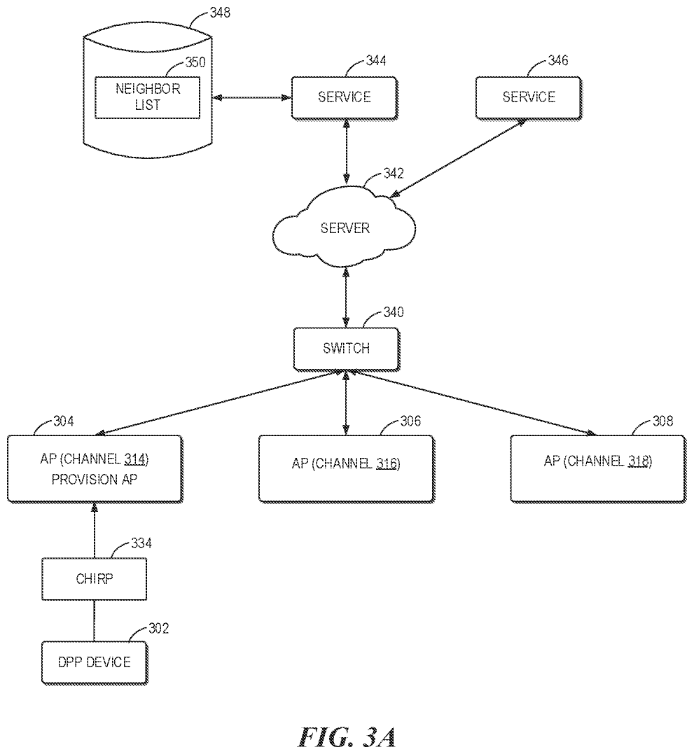

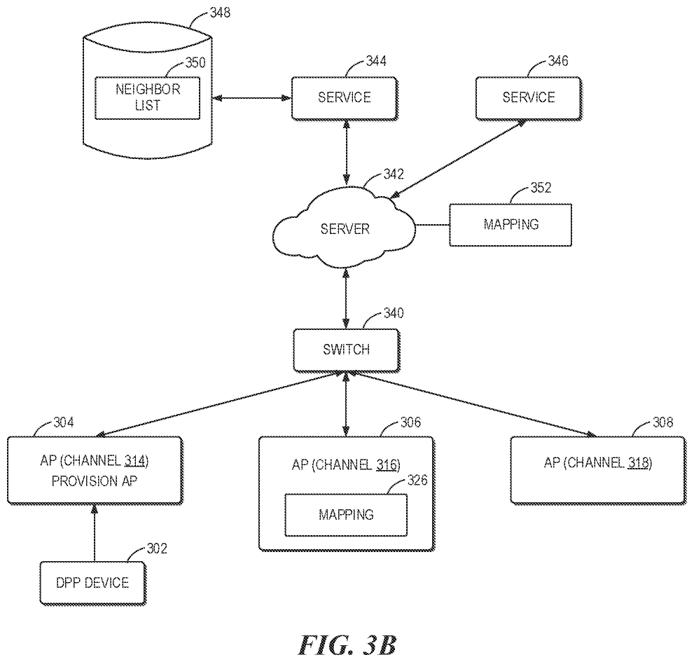

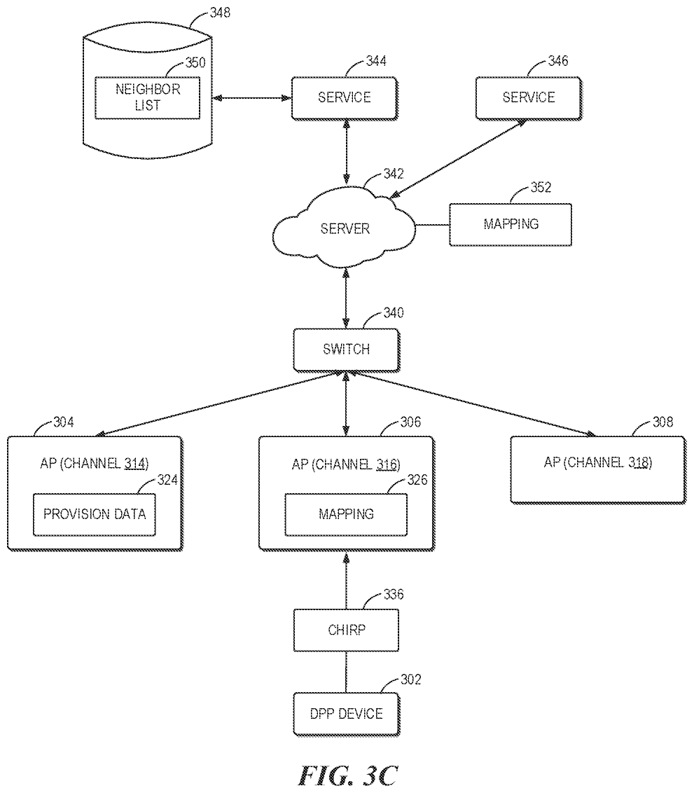

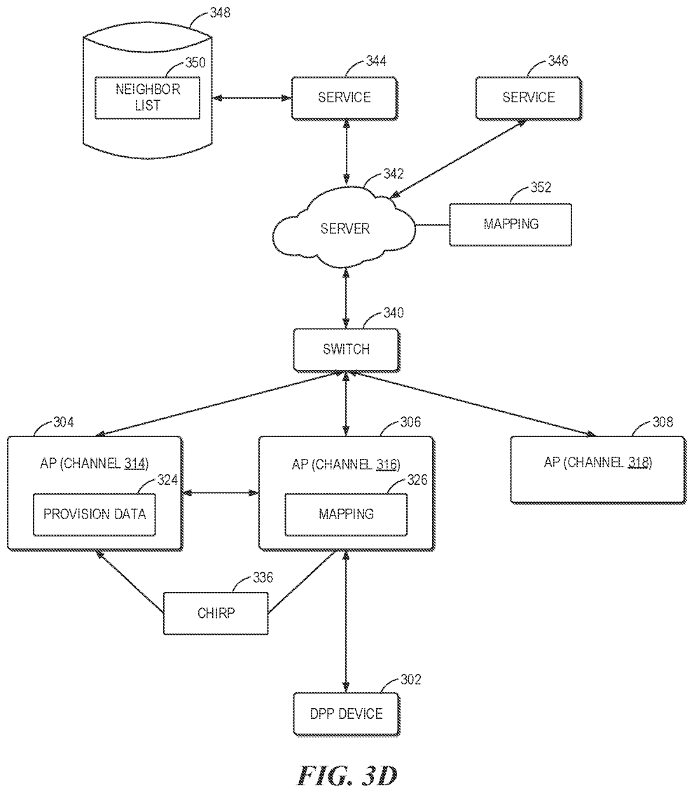

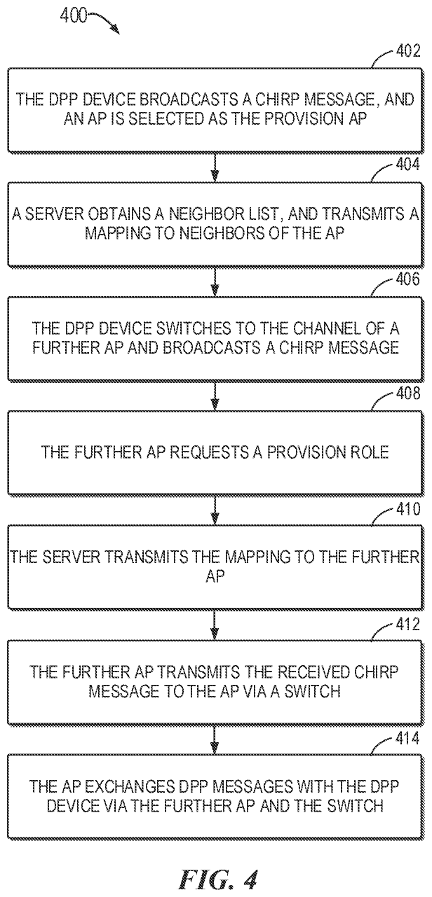

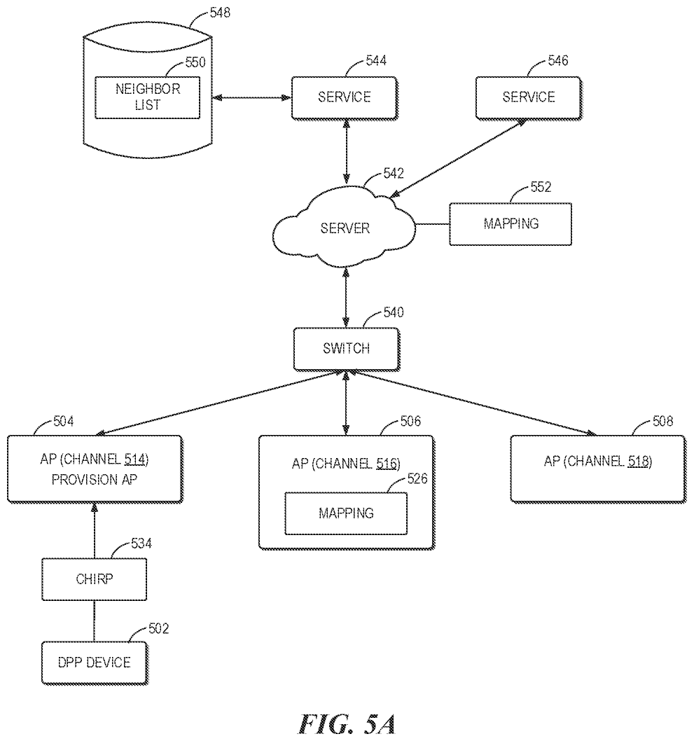

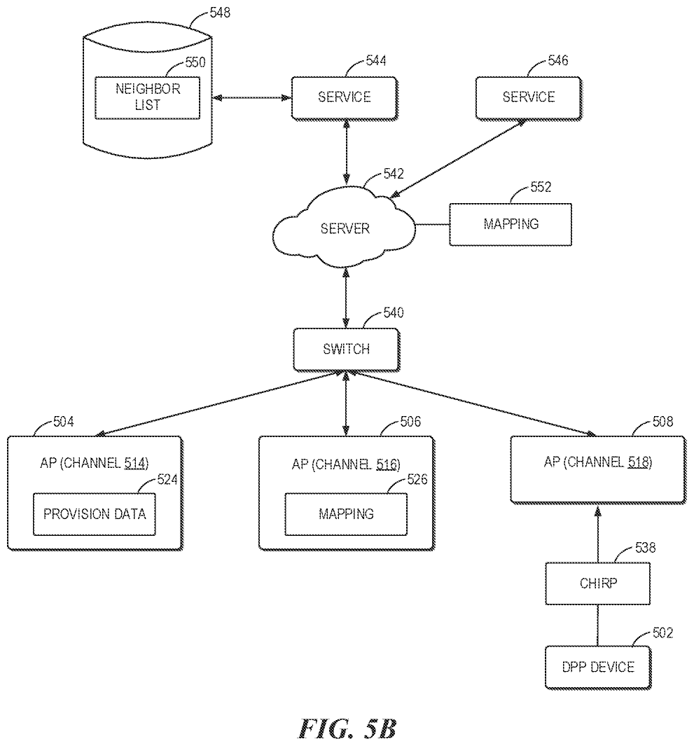

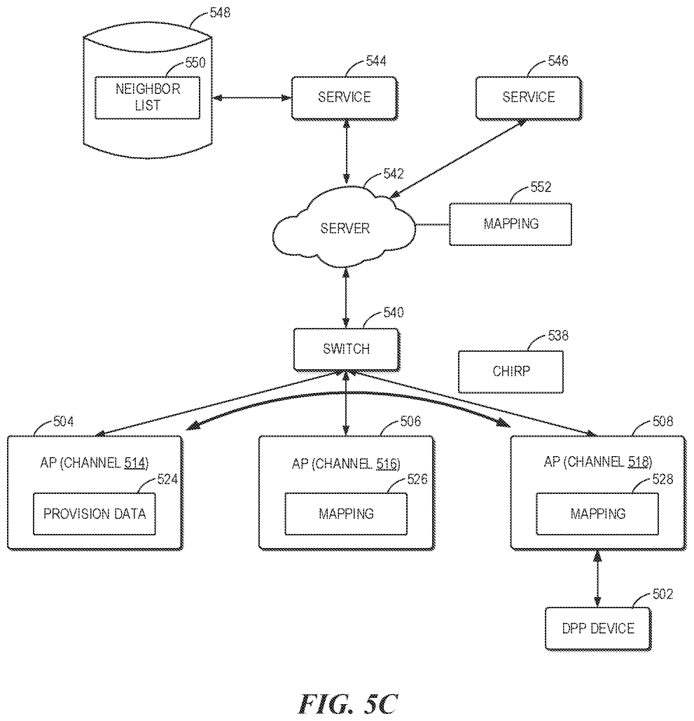

In some implementations, the non-provision AP receiving the chirp message from the DPP device is a neighbor of the provision AP for the DPP device. Therefore, the non-provision AP may have received a mapping of the DPP device and the provision AP when the provision AP obtains the provisioning role for the DPP device. In some implementations, the non-provision AP receiving the chirp message from the DPP device is not a neighbor of the provision AP for the DPP device. Therefore the non-provision AP does not know that the DPP device already has a provision AP. FIG. 2 and FIGS. 3A-3D illustrate an example process of exchanging messages between a DPP device and a provision AP via a non-provision AP which is a neighbor of the provision AP according to the implementations of the present disclosure, and FIG. 4 and FIGS. 5A-5C illustrate an example process of exchanging messages between a DPP device and a provision AP via a non-provision AP which is not a neighbor of the provision AP according to the implementations of the present disclosure.

FIG. 2 is a flow chart illustrating an example process 200 of exchanging messages between a DPP device and a provision AP via a non-provision AP which is a neighbor of the provision AP according to the implementations of the present disclosure. As shown in FIG. 2, at block 202, the DPP device broadcasts a chirp message, and an AP is selected as the provision AP. At block 204, a server obtains a neighbor list, and transmits a mapping of the DPP device and the AP to a further AP which is a neighbor of the AP. At block 206, the DPP device switches to the channel of the further AP and broadcasts a chirp message. At block 208, the further AP transmits the received chirp message to the AP in response to determining that the AP is provisioning the DPP device. At block 210, the AP exchanges DPP messages with the DPP device via the further AP.

The example process 200 is explained in more detail below in conjunction with FIGS. 3A-3D. FIG. 3A is a schematic diagram illustrating an example process of the DPP device broadcasting a chirp message, and an AP being selected as the provision AP. As shown in FIG. 3A, an AP 304 is working on a channel 314, an AP 306 is working on a channel 316, and an AP 108 is working on a channel 318. The APs 304, 306 and 308 are connected to a switch 340, and the AP 306 is a neighbor of the AP 304 but the AP 308 is not a neighbor of the AP 304. Backend services 344 and 346 run on a server 342, and they may select provision APs for wireless devices or may query a neighbor list 350 from a database 348. As shown in FIG. 3A, the DPP device 302 broadcasts a chirp message 334 on the channel 314. The AP 304 captures the chirp message 334 and transmits a request to the server 342 to apply a provisioning role for the DPP device 302. The backend service 344 (or 346) determines whether the DPP device 302 already has a provision AP, and may select the AP 304 as the provision AP for the DPP device 302 if the DPP device 302 does not has a provision AP yet.

FIG. 3B is a schematic diagram illustrating an example process of a server obtaining a neighbor list and transmitting a mapping of the DPP device and the AP to a further AP which is a neighbor of the AP. As shown in FIG. 3B, after selecting the AP 304 as the provision AP for the DPP device 302, the server 342 generates a mapping 352 of the DPP device 302 and the AP 304, which indicates that the provision AP of the DPP device 302 is the AP 304. Then, the server 342 obtains (or queries) the neighbor list 350 to find all neighbor APs of the AP 304, and the server 342 may transmit the mapping 352 to all these neighbor APs of the AP 304. In some implementations, the neighbor list 350 may have multiple entries, and each entry may include an AP and a list of neighbor APs of this AP. In some implementations, the neighbor list 350 may be generated based on chirp messages received from the APs 304, 306 and 308. In FIG. 3B, because the AP 306 is a neighbor of the AP 304, it receives the mapping 352 and stores the mapping 352 as a mapping 326. However, because the AP 308 is not a neighbor of the AP 304, the server 342 would not transmit the mapping 352 to the AP 308.

FIG. 3C is a schematic diagram illustrating an example process of the DPP device switching to the channel of the further AP and broadcasting a chirp message. As shown in FIG. 3C, after broadcasting the chirp message on the channel 314, the DPP device 302 may stay on the channel 314 for a period of time, for example 2 seconds. When the DPP device 302 stays on the channel 314 more than 2 seconds and does not receive a response message, it may switch to the next channel to broadcast another chirp message. In some cases, the DPP device 302 fails to receive a response message because it moves out of the scope of the AP 304, or because of a long latency between the AP 304 and the server 342. Therefore, the DPP device 302 switches from the channel 314 to the channel 316, and broadcasts a chirp message 336. As a result, the DPP device 302 may not be able to communicate with the AP 304, and only the AP 306 is able to listen messages from the DPP device 302. In this situation, the AP 304 may hold the provisioning role for the DPP device 302 for a period of time, for example 2 minutes, and the AP 304 may receive the provision data 324 from the server 342 to response the chirp message after the leaving of the DPP device 302. Then, the AP 304 may cache the received provision data 324.

FIG. 3D is a schematic diagram illustrating an example process of the further AP transmitting the received chirp message to the AP in response to determining that the AP is provisioning the DPP device, and the AP exchanging DPP messages with the DPP device via the further AP. As shown in FIG. 3D, after receiving the chirp message 336 from the DPP device 302, the AP 306 looks up the mappings relating to the DPP device 302, and determines that the AP 304 is provisioning the DPP device 302 based on the mapping 326. Then, the AP 306 transmit the received chirp message 336 to the AP 304 rather than requesting the server 342 to apply a provisioning role.

As shown in FIG. 3D, after receiving the chirp message 336, the AP 304 may select the AP 306 as a temporary communicating AP for the DPP device 302. In some implementations, the AP 304 may determine a signal strength of a signal received from the AP 306. For example, the signal received from the AP 306 may be the signal of the chirp massage 336. Furthermore, the AP 304 may compare the signal strength with a predefined threshold value. In response to determining that the signal strength is greater than a threshold value, the AP 304 may select the AP 306 as the temporary communicating AP for the DPP device 302. Then, the AP 304 transmits an authentication request based on the cached provision data 324 to the DPP device 302 via the AP 306. Therefore, the AP 304 can exchange messages with the DPP device 302 via the AP 306. In this situation, the AP 304 is the provision AP for the DPP device 302 and holds the provisioning session, and the authentication process is transparent to the AP 306.

In this manner, when the non-provision AP receives a chirp message from a DPP device, it may aware that the DPP device already has a provision AP based on a previously received mapping of the DPP device and its provision AP. Therefore, the non-provision AP does not need to transmit a request to the server to apply the provisioning role for the DPP device. Furthermore, even if the non-provision AP transmits the request, it will fail to be selected as the provision AP for the DPP device, because the provision AP will hold the provisioning role for a period of time. The non-provision AP may transmit the received chirp message to the provision AP for the DPP device, and the provision AP may exchange messages with the DPP device via the non-provision AP. Therefore, the DPP device can be provisioned without waiting until the end of the period of time or returning to the channel of the provision AP. Thus, the provisioning ability of the provision AP can be extended to other non-provision APs. In addition, the DPP device may be provisioned once the provision data is ready at the provision AP, thus the time for provisioning can be reduced, and the user experience can be improved.

In some implementations, the non-provision AP receiving the chirp message from the DPP device is not a neighbor of the provision AP for the DPP device. Therefore, the non-provision AP would not receive the mapping of the DPP device and the provision AP when the provision AP obtains the provisioning role for the DPP device, thus the non-provision AP does not know that the DPP device already has a provision AP. FIG. 4 and FIGS. 5A-5C illustrate an example process of exchanging messages between a DPP device and a provision AP via a non-provision AP which is not a neighbor of the provision AP according to the implementations of the present disclosure.

FIG. 4 is a flow chart illustrating an example process 400 of exchanging messages between a DPP device and a provision AP via a non-provision AP which is a neighbor of the provision AP according to the implementations of the present disclosure. As shown in FIG. 4, at block 402, the DPP device broadcasts a chirp message, and an AP is selected as the provision AP. At block 404, a server obtains a neighbor list, and transmits a mapping of the DPP device and the AP to neighbors of the AP. At block 406, the DPP device switches to the channel of the further AP and broadcasts a chirp message. At block 408, the further AP requests a provisioning role. At block 410, the server transmits the mapping of the DPP device and its provision AP to the further AP. At block 412, the further AP transmits the received chirp message to the AP via a switch. At block 414, the AP exchanges DPP messages with the DPP device via the further AP and the switch.

The example process 400 is explained in more detail below in conjunction with FIGS. 5A-5C. FIG. 5A is a schematic diagram illustrating an example process of a server transmitting a mapping of the DPP device and the AP to neighbors of the AP. As shown in FIG. 5A, an AP 504 is working on a channel 514, an AP 506 is working on a channel 516, and an AP 508 is working on a channel 518. The APs 504, 506 and 508 are connected to a switch 540, and the AP 506 is a neighbor of the AP 504 but the AP 508 is not a neighbor of the AP 504. Backend services 544 and 546 run on a server 542, and they may select provision APs for wireless devices or may query a neighbor list 550 from a database 548. As shown in FIG. 5A, the DPP device 502 broadcasts a chirp message 534 on the channel 514. The AP 504 captures the chirp message 534 and transmits a request to the server 542 to apply a provisioning role for the DPP device 502. The backend service 544 (or 546) determines whether the DPP device 502 already has a provision AP, and may select the AP 504 as the provision AP for the DPP device 502 if the DPP device 502 does not has a provision AP yet.

As shown in FIG. 5A, after selecting the AP 504 as the provision AP for the DPP device 502, the server 542 generates a mapping 552 of the DPP device 502 and the AP 504, which indicates that the provision AP of the DPP device 502 is the AP 504. Then, the server 542 obtains (or queries) the neighbor list 550 to find all neighbor APs of the AP 504, and the server 542 may transmit the mapping 552 to all these neighbor APs of the AP 504. In FIG. 5A, the AP 506 receives the mapping 552, and the AP 508 would not receive the mapping 552 because it is not a neighbor of the AP 504.

FIG. 5B is a schematic diagram illustrating an example process of the DPP device switching to the channel of the further AP and broadcasting a chirp message, and the further AP requesting a provisioning role. As shown in FIG. 5B, after broadcasting the chirp message on the channel 514, the DPP device 502 may stay on the channel 514 for a period of time, for example 2 seconds. When the DPP device 502 stays on the channel 514 more than 2 seconds and does not receive a response message, it may switch to the next channel to broadcast another chirp message. As shown in FIG. 5B, the DPP device 502 switches from the channel 514 to the channel 518, and broadcasts a chirp message 538. The AP 504 may hold the provisioning role for the DPP device 502 for a period of time, for example 2 minutes, and the AP 504 may receive the provision data 524 from the server 542 to response the chirp message after the leaving of the DPP device 502. Then, the AP 504 may cache the received provision data 524.

In some implementations, before switching to the channel 518, the DPP device 502 may switch from the channel 514 to the channel 516 and broadcast a chirp message on the channel 516. In this situation, the AP 506 may transmit the received chirp message to the AP 504 based on the mapping 526 (as described in the description associated with the process 200). However, if the DPP device 502 is moving and moves out of the scope of the AP 506, or the provision data 524 is not ready, the DPP device 502 may cannot receive a response message from the AP 506. Therefore, the DPP device 502 may switch from the channel 516 to the channel 518.

As shown in FIG. 5B, after receiving the chirp message 538, the AP 508 may determine whether a mapping of the DPP device 502 and its provision AP exists. Because the mapping 552 is not transmitted to the AP 508, therefore the AP 508 determines that a mapping of the DPP device 502 and its provision AP does not exist. Then, the AP 508 may transmit a request to be a provision AP for the DPP device 502 to the server 542.

FIG. 5C is a schematic diagram illustrating an example process of the server transmitting the mapping of the DPP device and its provision AP to the further AP, the further AP transmitting the received chirp message to the AP via a switch, and the AP exchanging DPP messages with the DPP device via the further AP and the switch. As shown in FIG. 5C, after receiving a request of applying a provisioning role from the AP 508, the server 542 may determine whether the DPP device 502 already has a provision AP. When the server 542 checks the mapping 552, it may determine that the AP 504 is provisioning the DPP device 502. Then, the server 542 may transmit the mapping 552 to the AP 508, and the AP 508 may store the mapping 552 as the mapping 528. Therefore, the AP 508 may know that the AP 504 is provisioning the DPP device 502.

As shown in FIG. 5C, when the AP 508 receives the chirp message 538 and knows that the AP 504 is provisioning the DPP device 502, the AP 508 attempts to transmit the chirp message 538 to the AP 504. However, because the AP 508 is far away the AP 504, it cannot communicate with the AP 504 directly. Therefore, the AP 508 may transmit the chirp message 538 to the switch 540, and the switch 540 may transmit the received chirp message 538 to the AP 504. In some implementations, both of the APs 504 and 508 are wired to the switch 540, thus the transmission between the APs 504 and 508 is fast.

As shown in FIG. 5C, after receiving the chirp message 538 from the AP 508 via the switch 540, the AP 504 may determine whether the provision data 524 is ready. If the provision data 524 is ready, the AP 504 may transmit response message to the AP 508 via the switch 540. In some implementations, the response message may include an authentication request for the DPP device 502. Furthermore, the AP 508 may respond the DPP device 502 with the received response message.

In this manner, when the server receives a request for a provisioning role from a non-provision AP, it transmit the mapping of the DPP device and the provision AP to the non-provision AP. Therefore, the non-provision AP may communicate with the provision AP, such that messages can be exchanged between the DPP device and the provision AP via a switch and the non-provision AP. Otherwise, in some situations, the non-provision AP may be rejected by the server to provision the DPP device because a provision AP for the DPP device already exists and it will hold the provisioning role for a few minutes. Then, the DPP device may fail to receive response message and may switch to a next channel after the dwell time has elapsed. In some situations, the non-provision AP may successfully become the provision AP for the DPP device, but it is possible that the timeout issue occurs again. Thus, the implementations of the present disclosure may reduce the timeout issues. Furthermore, the implementations of the present disclosure may extend the provisioning ability of the provision AP to other APs far away from the provision AP. Therefore, the DPP provisioning time can be reduced.

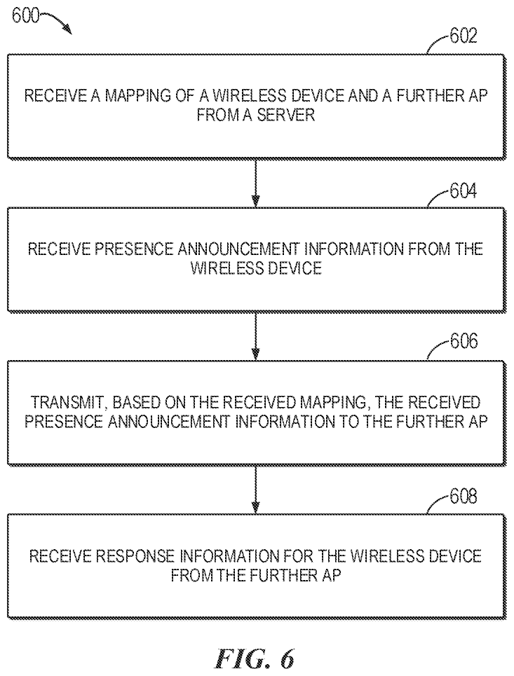

FIG. 6 is a flow chart illustrating a method 600, performed by an AP, for accelerating an authentication of a wireless device according to the implementations of the present disclosure. As shown in FIG. 6, at block 602, the AP may receive a mapping of a wireless device and a further AP from a server. For example, as shown in FIG. 1 and in the environment 100, the AP 106, which is a neighbor of the AP 104, may receive a mapping 152 from the server 142 when the AP 104 is selected to be a provision AP for a DPP device 102, where the mapping 152 indicates that the AP 104 is provisioning the DPP device 102. The AP 106 may store the received mapping 152 as a mapping 126.

At block 604, the AP may receive presence announcement information from the wireless device. For example, as shown in FIG. 1 and in the environment 100, the DPP device 102 is trying to connect to a network, and it may broadcast a chirp message 136 on the channel 116. The chirp message 136 is a presence announcement for announcing the presence of the DPP device 102. The AP 106 may capture the chirp message 136 on the channel 116.

At block 606, the AP may transmit, based on the received mapping, the received presence announcement information to the further AP. For example, as shown in FIG. 1 and in the environment 100, the AP 106 may know that the AP 104 is provisioning the DPP device 102 according to the received mapping 126. Then, the AP 106 may transmit the received chirp message 136 from the DPP device 102 to the AP 104.

At block 608, the AP may receive response information for the wireless device from the further AP, the response information including an authentication request for the wireless device. For example, as shown in FIG. 1 and in the environment 100, after receiving the chirp message 136 from the AP 106, the AP 104 may check whether the provision data 124 for responding the chirp message 136 has been received from the server 142 and cached in the AP 104. If the provision data 124 is ready, the AP 104 may transmit response information including an authentication request for the DPP device 102 to the AP 106. Therefore, the AP 106 may receive the response information from the AP 104.

At block 610, the AP may transmit the response information to the wireless device. For example, as shown in FIG. 1 and in the environment 100, after receiving the response information from the AP 104, the AP 106 may transmit the received response information to the DPP device 102. Therefore, the DPP device 102 can be provisioned, and it can exchange DPP messages with the provision AP 104 via the non-provision AP 106.

In this manner, the provisioning ability of the provision AP can be extended to the non-provision AP, such that the provisioning area of the provision AP can be extended. Furthermore, when the DPP device leaves the channel of the provision AP (e.g., the dwell time is up or the DPP device moves out of the area of the provision AP), it can be provisioned without waiting for the validity period of the provisioning role to expire or for the DPP device to return to the channel of the provision AP. Thus, the provisioning time can be reduced and the provisioning process can be accelerated.

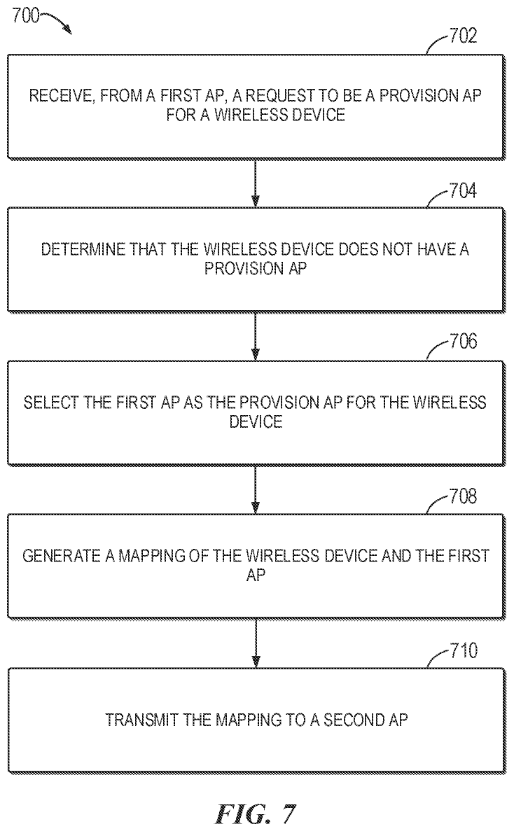

FIG. 7 is a flow chart illustrating a method 700, performed by a server, for accelerating the provisioning of a wireless device according to the implementations of the present disclosure. As shown in FIG. 7, at block 702, the server may receive, from a first AP, a request to be a provision AP for a wireless device. For example, as shown in FIG. 1 and in the environment 100, the server 142 may receive a request to be a provision AP for the DPP device 102 from the AP 104. The request may be transmitted by the AP 104 in response to receiving a chirp message 134 from the DPP device 102.

At block 704, the server may determine that the wireless device does not have a provision AP. For example, as shown in FIG. 1 and in the environment 100, the server 142 may determine that the DPP device 102 does not have a provision AP. At the block 706, the server may select the first AP as the provision AP for the wireless device. For example, in the environment 100, the server 142 may select the AP 104 as the provision AP for the DPP device 102 in response to determining that the DPP device 102 does not have a provision AP yet.

At block 708, the server may generate a mapping of the wireless device and the first AP. For example, as shown in FIG. 1 and in the environment 100, when the AP 104 is selected as the provision AP for the DPP device 102, the server 142 may generate a mapping 152 of the DPP device 102 and the AP 104, where the mapping 152 indicating that the AP 104 is provisioning the DPP device 102.

At block 710, the server may transmit the mapping of the wireless device and the first AP to a second AP, where the mapping is used by the second AP for authenticating the wireless device through the first AP. For example, as shown in FIG. 1 and in the environment 100, after generating the mapping 152, the server 142 may obtain a neighbor list 150 stored in the database 148 to obtain all neighbors of the AP 104. Then, the server 142 may transmit the mapping 152 to the AP 106 which is a neighbor of the AP 104. Therefore, the AP 106 may use the mapping 152 to authenticate the DPP device 102. For example, the AP 106 may store the mapping 152 as the mapping 126. When the AP 106 receives a chirp message 136 from the DPP device 102, it may transmit the chip message 136 to the AP 104 based on the mapping 126 to authenticate the DPP device 102.

In this manner, the non-provision AP may transmit a received chirp message from a DPP device to a provision AP for the DPP device based on the mapping received from the server. Therefore, the provision AP can exchange messages for provisioning the DPP device. Thus, the provisioning ability of the provision AP can be extended, and the provisioning time can be reduced.

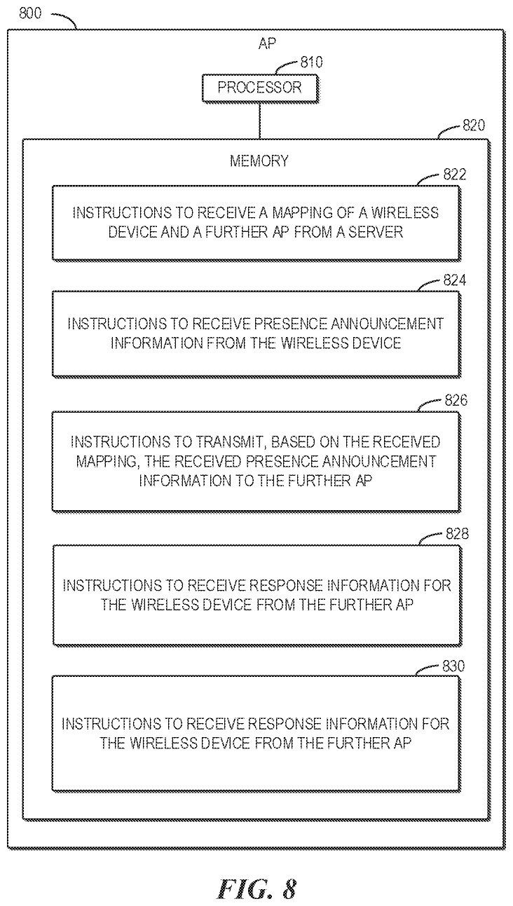

FIG. 8 is a diagram illustrating an example AP 800 according to the implementations of the present disclosure. As shown in FIG. 8, the AP 800 comprises at least one processor 810, and a memory 820 coupled to the at least one processor 810. The memory 820 stores instructions 822, 824, 826, 828 and 830 to cause the processor 810 to perform actions according to example implementations of the present disclosure.

As shown in FIG. 8, the memory 820 stores instructions 822 to receive a mapping of a wireless device and a further AP from a server, the mapping indicating that the further AP is a provision AP for the wireless device. The memory 820 further stores instructions 824 to receive presence announcement information from the wireless device. The memory 820 further stores instructions 826 to transmit, based on the received mapping, the received presence announcement information to the further AP. The memory 820 further stores instructions 828 to receive response information for the wireless device from the further AP, the response information including an authentication request for the wireless device. The memory 820 further stores instructions 830 to transmit the response information to the wireless device.

In this manner, the provisioning ability of the provision AP can be extended to the non-provision AP, such that the provisioning area of the provision AP can be extended. Furthermore, the provisioning time can be reduced and the provisioning process can be accelerated.

The stored instructions and the functions that the instructions may perform can be understood with reference to implementations as described above. For brevity, the details of instructions 822, 824, 826, 828 and 830 will not be discussed herein.

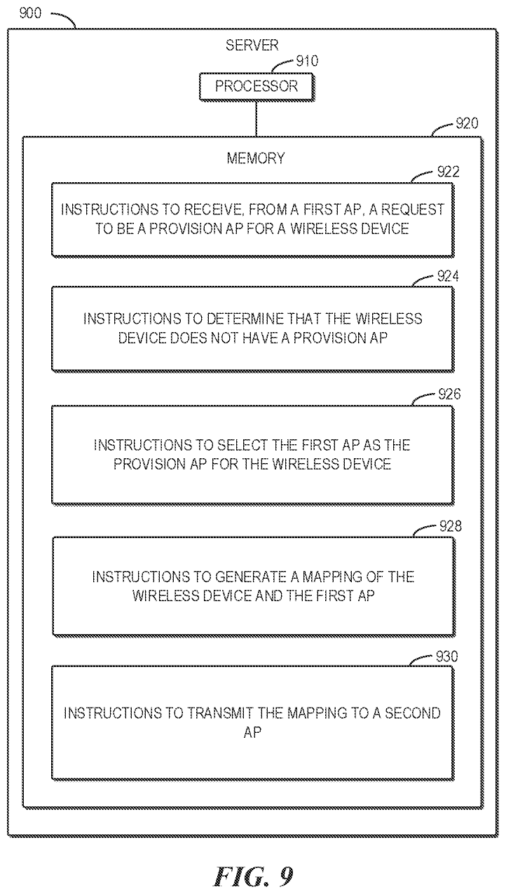

FIG. 9 is a diagram illustrating an example server 900 according to the implementations of the present disclosure. As shown in FIG. 9, the server 900 comprises at least one processor 910, and a memory 920 coupled to the at least one processor 910. The memory 920 stores instructions 922, 924, 926, 928 and 930 to cause the processor 910 to perform actions according to example implementations of the present disclosure.

As shown in FIG. 9, the memory 920 stores instructions 922 to receive, from a first access point (AP), a request to be a provision AP for a wireless device. The memory 920 further stores instructions 924 to determine that the wireless device does not have a provision AP. The memory 920 further stores instructions 926 to select the first AP as the provision AP for the wireless device. The memory 920 further stores instructions 928 to generate a mapping of the wireless device and the first AP. The memory 920 further stores instructions 930 to transmit the mapping of the wireless device and the first AP to a second AP, the mapping being used by the second AP for authenticating the wireless device through the first AP.

In this manner, the non-provision AP may transmit a received chirp message from a DPP device to a provision AP for the DPP device based on the mapping received from the server. Therefore, the provision AP can exchange messages for provisioning the DPP device. Thus, the provisioning ability of the provision AP can be extended, and the provisioning time can be reduced.

The stored instructions and the functions that the instructions may perform can be understood with reference to implementations as described above. For brevity, the details of instructions 922, 924, 926, 928 and 930 will not be discussed herein.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. An access point (AP) comprising:
at least one processor; and
a memory coupled to the at least one processor, the memory storing instructions to cause the at least one processor to:
receive a mapping of a wireless device and a further AP from a server, the mapping indicating that the further AP is a provision AP for the wireless device;
receive presence announcement information from the wireless device;
transmit, based on the received mapping, the received presence announcement information to the further AP;
receive response information for the wireless device from the further AP, the response information including an authentication request for the wireless device; and
transmit the response information to the wireless device.

2. The AP of claim 1, wherein the memory further stores instructions to cause the at least one processor to:
after receiving the presence announcement information from the wireless device, determine that a mapping of the wireless device and the further AP does not exist; and
transmit, to the server, a request to be a provision AP for the wireless device.

3. The AP of claim 2, wherein the memory further stores instructions to cause the at least one processor to:
receive the mapping of the wireless device and the further AP from the server without being selected as a provision AP for the wireless device; and
transmit, based on the received mapping, the received presence announcement information to a switch connected to the further AP.

4. The AP of claim 1, wherein the wireless device is a first wireless device, the presence announcement information is first presence announcement information, and the memory further stores instructions to cause the at least one processor to:
receive second presence announcement information from a second wireless device;
determine that a mapping of the second wireless device and a provision AP for the second wireless device does not exist; and
transmit, to the server, a request to be the provision AP for the second wireless device.

5. The AP of claim 4, wherein the memory further stores instructions to cause the at least one processor to:
receive, from the server, provision data for provisioning the second wireless device; and
cache the received provision data.

6. The AP of claim 5, wherein the AP is a first AP, the further AP is a second AP, and the memory further stores instructions to cause the at least one processor to:
receive the second a from a third AP;
determine a signal strength of a signal received from the third AP;
select the third AP as a temporary communicating AP for the second wireless device based on the signal strength of the signal; and
transmit the cached provision data as response information to the third AP.

7. The AP of claim 6, wherein the instructions to select the third AP as a temporary communicating AP for the second wireless device comprise instructions to cause the at least one processor to:
compare the signal strength of the signal received from the third AP; and
in response to determining that the signal strength is greater than a threshold value, select the third AP as the temporary communicating AP for the second wireless device.

8. The AP of claim 1, wherein the wireless device accesses a network via a Device Provisioning Protocol, and the presence announcement information is DPP presence announcement information.

9. A server comprising:
at least one processor; and
a memory coupled to the at least one processor, the memory storing instructions to cause the at least one processor to:
receive, from a first access point (AP), a request to be a provision AP for a wireless device;
determine that the wireless device does not have a provision AP;
select the first AP as the provision AP for the wireless device;
generate a mapping of the wireless device and the first AP; and
transmit the mapping of the wireless device and the first AP to a second AP, the mapping being used by the second AP for authenticating the wireless device through the first AP.

10. The server of claim 9, wherein the memory further stores instructions to cause the at least one processor to:
transmit provision data for provisioning the wireless device to the first AP.

11. The server of claim 10, wherein the instructions to transmit the mapping of the wireless device and the first AP to the second AP comprise instructions to cause the at least one processor to:
obtain a neighbor AP list for the first AP; and
transmit the mapping of the wireless device and the first AP based on the neighbor AP list.

12. The server of claim 9, wherein the memory further stores instructions to cause the at least one processor to:
receive, from a third AP, a request to be the provision AP for the wireless device;
determine that the wireless device has the provision AP based on the mapping of the wireless device and the first AP; and
transmit the mapping of the wireless device and the first AP to the third AP without selecting the third AP as the provision AP.

13. A method comprising:
receiving, by an access point (AP), a mapping of a wireless device and a further AP from a server, the mapping indicating that the further AP is a provision AP for the wireless device;
receiving, by the AP, presence announcement information from the wireless device;
transmitting, by the AP and based on the received mapping, the received presence announcement information to the further AP;
receiving, by the AP, response information for the wireless device from the further AP, the response information including an authentication request for the wireless device; and
transmitting, by the AP, the response information to the wireless device.

14. The method of claim 13, wherein the method further comprises:
determining, by the AP, that a mapping of the wireless device and the further AP does not exist; and
transmitting, by the AP and to the server, a request to be a provision AP for the wireless device.

15. The method of claim 14, wherein the method further comprises:
receiving, by the AP, the mapping of the wireless device and the further AP from the server without being selected as a provision AP for the wireless device; and
transmitting, by the AP, based on the received mapping, the received presence announcement information to a switch connected to the further AP.

16. The method of claim 13, wherein the wireless device is a first wireless device, the presence announcement information is first presence announcement information, and the method further comprises:
receiving, by the AP, second presence announcement information from a second wireless device;
determining, by the AP, that a mapping of the second wireless device and a provision AP for the second wireless device does not exist; and
transmitting, by the AP and to the server, a request to be the provision AP for the second wireless device.

17. The method of claim 16, wherein the method further comprises:
receiving, by the AP and from the server, provision data for provisioning the second wireless device; and
caching, by the AP, the received provision data.

18. The method of claim 17, wherein the AP is a first AP, the further AP is a second AP, and the method further comprises:
receiving, by the AP, the second presence announcement information from a third AP;
selecting, by the AP, the third AP as a temporary communicating AP for the second wireless device; and
transmitting, by the AP, the cached provision data as response information to the third AP.

19. The method of claim 18, wherein selecting the third AP as a temporary communicating AP for the second wireless device comprises:
determining a signal strength of a signal received from the third AP; and
in response to determining that the signal strength is greater than a threshold value, selecting the third AP as the temporary communicating AP for the second wireless device.

20. The method of claim 13, wherein the wireless device accesses a network via a Device Provisioning Protocol, and the presence announcement information is DPP presence announcement information.
